(19) United States
(12) Patent Application Publication
(10) Pub. No.: US 2020/0307854 A1
(43) Pub. Date: Oct. 1, 2020

(54) FLIP-CLOSURE COSMETIC-PRODUCT PACKAGING AND METHOD OF MANUFACTURING THEREOF

(71) Applicant: Pat McGrath Cosmetics LLC, New York, NY (US)

(72) Inventor: Patricia McGrath, New York, NY (US)

(21) Appl. No.: 16/369,324

(22) Filed: Mar. 29, 2019

(51) Int. Cl. B65D 5/66; B65D 5/48; B31B 50/00; B31B 50/26; B31B 50/62; B31B 50/74

(52) U.S. Cl. CPC B65D 5/6602; B65D 5/48014; B31B 50/004; B31B 2100/0024; B31B 50/62; B31B 50/74; B31B 50/26

(57) ABSTRACT

Disclosed is a cosmetic-product packaging, wherein the cosmetic-product packaging is manufactured to be an elongate packaging with a plurality of planar side panels, a first end panel and a second end panel; the second end panel is implemented as a lid that is pivotally attached to at least a first planar side panel of the plurality of planar side panels, wherein the lid includes a distal hand-digit-slidable flap panel that is tuckable into a retaining slot formed on at least a second planar side panel of the plurality of planar side panels; and the elongate packaging surrounds an internal region thereof for accommodating one or more cosmetic products that are user-accessible when the distal hand-digit-slidable flap panel is hand-digit-slid out of the retaining slot to pivot the lid into an open state.

### TECHNICAL FIELD

The present disclosure relates generally to cosmetic-product packaging; and more specifically, to flip-closure cosmetic-product packaging. Furthermore, the present disclosure also relates to a methods of manufacturing aforesaid cosmetic-product packaging.

### BACKGROUND

Cosmetic products for human beautification purposes are well known and have been used by humans for thousands of years. Such cosmetic products have more recently been provided to customers in various types of packaging (for example, such as paper packaging, plastics-material packaging, fabric packaging and the like) for providing cosmetic product protection en route from cosmetic products manufactures to eventual customers. However, many customers, namely users, discard the cosmetic-product packaging after purchasing the cosmetic products.

More recently, there has been a growing concern about adapting human society to a more sustainable utilization of resources, such as more sustainable use of energy and materials, with an emphasis on reducing waste, and in particular, plastics-material waste that can result in plastics-material nanoparticles in rivers and oceans. Therefore, recycling and re-use are important issues for such sustainable utilization of resources used in manufacturing of the cosmetic-product packaging.

Therefore, there arises a need for a cosmetic-product packaging that not only provides protection for a given cosmetic product from a given manufacturer to a given customer, but aesthetically appeals and is useful to the given customer, for example for adapting to other practical uses, such that the given customer retains and cherishes the cosmetic-product packaging for long-term use, rather than merely discarding the cosmetic-product packaging at an earliest opportunity.

### SUMMARY

The present disclosure seeks to provide an improved cosmetic-product packaging.

The present disclosure also seeks to provide an improved method of (for) manufacturing a cosmetic-product packaging.

Moreover, the present disclosure seeks to provide at least a partial solution to an existing technical problem of wastage and improper waste management of packaging of cosmetic products. An aim of the present disclosure is to provide a solution that at least partially overcomes the aforesaid problems encountered in known art.

In one aspect, an embodiment of the present disclosure provides a cosmetic-product packaging, wherein the cosmetic-product packaging is manufactured to be an elongate packaging with a plurality of planar side panels, a first end panel and a second end panel;

the second end panel is implemented as a lid that is pivotally attached to at least a first planar side panel of the plurality of planar side panels, wherein the lid includes a distal hand-digit-slidable flap panel that is tuckable into a retaining slot formed on at least a second planar side panel of the plurality of planar side panels; and

the elongate packaging surrounds an internal region thereof for accommodating one or more cosmetic products that are user-accessible when the distal hand-digit-slidable flap panel is hand-digit-slid out of the retaining slot to pivot the lid into an open state.

Embodiments of the present disclosure substantially eliminate, or at least partially address, the aforementioned problems in the prior art and allow for a substantial reduction in wastage of resources used in manufacturing the cosmetic-product packaging. Additionally, the present disclosure provides an improved cosmetic-product packaging that is more appealing, durable and useful to users, such that the users retain the cosmetic-product packaging for various purposes, for example, such as storage, transportation and protection of the one or more cosmetic products. Yet additionally, the present disclosure provides an improved cosmetic-product packaging that is easier for handicapped user to employ, when their hand dexterity is at least partially impaired.

Optionally, a distal end of the lid is outwardly curved according to a first radius, and the retaining slot is curved to a second radius, wherein the first and second radii are mutually identical, such that the distal end of the lid overlays the retaining slot in a curved manner when the distal end is hand-digit-slid to overlay the retaining slot.

Optionally, the elongate packaging is fabricated from at least one of: a paper material, a cardboard material.

Optionally, the elongate packaging, in its internal region, includes an internal divider for accommodating in a spatially separated manner the one or more cosmetic products, wherein the internal divider is integral to the plurality of planar side panels, the first end panel and the second end panel, wherein these panels are formed from a single sheet of material during manufacture.

Optionally, the single sheet of material is adhesively bonded in at least a portion of its surface area.

Optionally, the single sheet of material has an outer surface that is printable with an image, and is wipe cleanable (namely, “wipe-clean”).

Optionally, the elongate packaging is fabricated from a liquid-absorbent material, and the internal divider separates the one or more cosmetic products to reduce smearing or cross-contamination between the one or more cosmetic products when stored in the cosmetic-product packaging.

Optionally, the internal divider defines a plurality of elongate compartments for receiving the one or more cosmetic products.

Optionally, the adhesive bonding is included along an elongate planar side panel of the plurality of planar panels to provide rigidity to the cosmetic-product packaging, and a distal planar panel of the internal divider is adhesively bonded to a same planar side panel into which the retaining slot is formed.

Optionally, the distal planar panel of the internal divider is adhesively bonded to a portion of the planar side panel in which the retaining slot is formed, wherein the portion is spatially remote from the retaining slot.

Optionally, a portion of the internal divider near the lid is devoid of the distal planar panel that is adhesively bonded to the planar side panel into which the retaining slot is formed.

Optionally, the distal hand-digit-slidable flap panel of the lid is provided on its exterior-facing surface with a friction-enhancing surface finish that enhances hand-digit frictional grip onto the distal hand-digit-slidable flap panel.

Optionally, the elongate packaging has a length in a range of 10 cm to 18 cm when in a closed state, a first lateral width in a range of 2 cm to 6 cm, and a second lateral width in a range of 1 cm to 3 cm.

In another aspect, an embodiment of the present disclosure provides a method of (for) manufacturing a cosmetic-product packaging, wherein the method includes:

(i) manufacturing the cosmetic-product packaging to be an elongate packaging with a plurality of planar side panels, a first end panel and a second end panel;

(ii) manufacturing the second end panel to be implemented as a lid that is pivotally attached to at least a first planar side panel of the plurality of planar side panels, wherein the lid includes a distal hand-digit-slidable flap panel that is tuckable into a retaining slot formed on at least a second planar side panel of the plurality of planar side panels; and

(iii) arranging for the elongate packaging to surround an internal region thereof for accommodating one or more cosmetic products that are user-accessible when the distal hand-digit-slidable flap panel is hand-digit-slid out of the retaining slot to pivot the lid into an open state.

Optionally, the method further includes manufacturing a distal end of the lid to be outwardly curved according to a first radius, and the retaining slot to be curved to a second radius, wherein the first and second radii are mutually identical, such that the distal end of the lid overlays the retaining slot in a curved manner when the distal end is hand-digit-slid to overlay the retaining slot.

Optionally, the method further includes fabricating the elongate packaging from at least one of: a paper material, a cardboard material.

Optionally, the method further includes arranging for the elongate packaging, in its internal region, to include an internal divider for accommodating in a spatially separated manner the one or more cosmetic products, wherein the internal divider is integral to the plurality of planar side panels, the first end panel and the second end panel, wherein these panels are formed from a single sheet of material during manufacture.

Optionally, in the method, the single sheet of material is adhesively bonded in at least a portion of its surface area.

Optionally, in the method, the single sheet of material has an outer surface that is printable with an image, and is wipe-cleanable (namely, “wipe-clean”).

Optionally, the method further includes fabricating the elongate packaging from a liquid-absorbent material, and arranging for the internal divider to separate the one or more cosmetic products to reduce smearing or cross-contamination between the one or more cosmetic products when stored in the cosmetic-product packaging.

Optionally, in the method, the internal divider defines a plurality of elongate compartments for receiving the one or more cosmetic products.

Optionally, in the method, the adhesive bonding is included along an elongate planar side panel of the plurality of planar panels to provide rigidity to the cosmetic-product packaging, and a distal planar panel of the internal divider is adhesively bonded to a same planar side panel into which the retaining slot is formed.

Optionally, in the method, the distal planar panel of the internal divider is adhesively bonded to a portion of the planar side panel in which the retaining slot is formed, wherein the portion is spatially remote from the retaining slot.

Optionally, the method further includes arranging for a portion of the internal divider near the lid to be devoid of the distal planar panel that is adhesively bonded to the planar side panel into which the retaining slot is formed.

Optionally, the method further includes providing the distal hand-digit-slidable flap panel of the lid on its exterior-facing surface with a friction-enhancing surface finish that enhances hand-digit frictional grip onto the distal hand-digit-slidable flap panel.

Optionally, the method further includes manufacturing the elongate packaging to have a length in a range of 10 cm to 18 cm when in a closed state, a first lateral width in a range of 2 cm to 6 cm, and a second lateral width in a range of 1 cm to 3 cm.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1 and 2 are illustrations of perspective views of a cosmetic-product packaging in a closed state, in accordance with an embodiment of the present disclosure;

FIG. 3 is an illustration of a perspective view of the cosmetic-product packaging of FIGS. 1 and 2 in an open state, in accordance with an embodiment of the present disclosure;

FIG. 4 is an illustration of a perspective view of a cosmetic-product packaging of depicting an internal region of a cosmetic-product packaging, in accordance with an embodiment of the present disclosure;

FIG. 5 is an illustration of a perspective view of a cosmetic-product packaging of depicting an internal region of a cosmetic-product packaging, in accordance with another embodiment of the present disclosure;

FIG. 6 is an illustration of a perspective view of a cosmetic-product packaging in use, in accordance with an embodiment of the present disclosure; and

FIG. 7 is an illustration of steps of a method of (for) manufacturing a cosmetic-product packaging, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a cosmetic-product packaging, wherein the cosmetic-product packaging is manufactured to be an elongate packaging with a plurality of planar side panels, a first end panel and a second end panel;

the second end panel is implemented as a lid that is pivotally attached to at least a first planar side panel of the plurality of planar side panels, wherein the lid includes a distal hand-digit-slidable flap panel that is tuckable into a retaining slot formed on at least a second planar side panel of the plurality of planar side panels; and

the elongate packaging surrounds an internal region thereof for accommodating one or more cosmetic products that are user-accessible when the distal hand-digit-slidable flap panel is hand-digit-slid out of the retaining slot to pivot the lid into an open state.

In another aspect, an embodiment of the present disclosure provides a method of (for) manufacturing a cosmetic-product packaging, wherein the method includes:

(i) manufacturing the cosmetic-product packaging to be an elongate packaging with a plurality of planar side panels, a first end panel and a second end panel;

(ii) manufacturing the second end panel to be implemented as a lid that is pivotally attached to at least a first planar side panel of the plurality of planar side panels, wherein the lid includes a distal hand-digit-slidable flap panel that is tuckable into a retaining slot formed on at least a second planar side panel of the plurality of planar side panels; and

(iii) arranging for the elongate packaging to surround an internal region thereof for accommodating one or more cosmetic products that are user-accessible when the distal hand-digit-slidable flap panel is hand-digit-slid out of the retaining slot to pivot the lid into an open state.

The present disclosure provides the cosmetic-product packaging and the method of (for) manufacturing the aforesaid cosmetic-product packaging. The cosmetic-product packaging disclosed herein is cost efficient and user friendly when in operation. Such a cosmetic-product packaging allows a given user to store and access conveniently the one or more cosmetic products. Additionally, the cosmetic-product packaging provides an enhanced protection to the one or more cosmetic products stored therein. Specifically, the cosmetic-product packaging substantially reduces a possibility of physical damage and accidental damage that may severely impact the one or more cosmetic products. The cosmetic-product packaging disclosed herein can be manufactured using less resources, for example minimal resources, thereby allowing for a substantial reduction in wastage of resources whilst manufacturing the cosmetic-product packaging. Furthermore, the cosmetic-product packaging is reusable and recyclable. Therefore, the cosmetic-product packaging is more environmentally friendly. It will be appreciated that, optionally, the cosmetic-product packaging is aesthetically appealing to users.

Throughout the present disclosure, the term “cosmetic product” refers to a synthetic chemical and/or nature-based beauty product such as a lipstick, an eye-liner, a hand cream, a face mask, and the like, that is used by a given user for beautification purposes. Generally, the user applies one or more cosmetic products on himself/herself for improving his/her visual appearance. Typically, the one or more cosmetic products has a body which is in a form of a bottle, a sachet, a tube, a cylindrical container and the like. The body of the one or more cosmetic products is made from materials like glass, plastics materials, fiber or any other material capable of containing the one or more cosmetic products within the body.

Throughout the present disclosure, the term “cosmetic-product packaging” relates to an outer covering (namely, packaging) employed to store, transport and protect the one or more cosmetic products. Notably, the cosmetic-product packaging relates to a protective covering of the one or more cosmetic products for distribution, storage, sale and use thereof. The cosmetic-product packaging is designed to be opened and closed for storing or accessing the one or more cosmetic products. Beneficially, the cosmetic-product packaging protects the one or more cosmetic products from any damage caused by physical impacts (for example, such as falls, crushing, rough handling, friction with surfaces or other objects, and the like) and any other accidental factors (such as heat damage, spillage damage, and the like). Furthermore, the cosmetic-product packaging could also facilitate in prolonging shelf-life of the one or more cosmetic products arranged therein.

The cosmetic-product packaging is manufactured to be an elongate packaging. Throughout the present disclosure, the term “elongate packaging” refers to a packaging having a given length and a given width, wherein the given length is substantially longer than the given width. Notably, a shape and size of the elongate packaging is chosen according to a shape and size of the one or more cosmetic products, in order to suitably accommodate the one or more cosmetic products within the cosmetic-product packaging. Furthermore, the elongate packaging has a three-dimensional geometrical shape, for example, such as a cuboidal shape, a cubical shape, a polygonal prism shape (for example, such as a hexagonal prism shape, a pentagonal prism shape, and the like), a pyramid shape, and the like.

Optionally, the elongate packaging is fabricated from at least one of: a paper material, a cardboard material. The cardboard material could be cardstock material, chipboard material, corrugated cardboard material, honeycomb board, and the like. Notably, such materials are lightweight, easily available, easy to handle and inexpensive. Beneficially, such materials are also environment friendly and can be easily reused and/or recycled.

Optionally, the elongate packaging is fabricated from a combination of the paper material and the cardboard materials.

Alternatively, optionally, the elongate packaging is fabricated from at least one of: a plastics material, a non-metallic material (for example, such as wood), a metal.

As mentioned previously, the elongate packaging has the plurality of planar side panels, the first end panel and the second end panel. Throughout the present disclosure, the term “planar side panels” refers to substantially-flat components that form an elongate portion of the elongate packaging, the “first end panel” refers to a substantially-flat component that forms a first end of the cosmetic-product packaging and the “second end panel” refers to a substantially-flat component that forms a second end of the cosmetic-product packaging. Notably, the plurality of the planar side panels is arranged to form a length of the elongate packaging whereas the first end panel and the second end panel are arranged to form a width of the elongate packaging. Optionally, the plurality of the planar side panels, the first end panel and the second end panel of the elongate packaging collectively form a container-like arrangement that can be used to store the one or more cosmetic products therein whilst providing protection to the one or more cosmetic products. In an example, the cosmetic-product packaging may be manufactured as an elongate cuboidal packaging. In such an example, the elongate packaging may have four planar side panels, one first end panel and one second end panel, wherein all such panels are rectangular in shape.

Optionally, the first end panel is implemented as a planar cover. In such a case, the planar cover permanently covers the first end of the cosmetic-product packaging. Furthermore, a shape and size of the planar cover corresponds to a shape and size of the first end of the cosmetic-product packaging. Beneficially, such a planar cover provides rigidity to the cosmetic-product packaging.

Alternatively, optionally, the first end panel is implemented as a foldable cover that is pivotally coupled to any one of the planar side panels among the plurality of the planar side panels. Notably, the foldable cover serves as a movable covering of the cosmetic-product packaging. The foldable cover can be pivotally moved to cover the first end of the cosmetic-product packaging for completely enclosing the one or more cosmetic products packaging within the cosmetic-product packaging. Alternatively, the foldable cover can be pivotally moved to uncover the first end for accessing the one or more cosmetic products from the first end of the cosmetic-product packaging.

The second end panel is implemented as the lid that is pivotally attached to at least the first planar side panel of the plurality of planar side panels. In other words, the lid forms the second end panel of the elongate packaging. Notably, the lid serves as a covering of the cosmetic-product packaging, such covering being pivotally attached to the elongate packaging along at least the first planar side panel. The lid can be pivotally moved to cover the second end of the cosmetic-product packaging for completely enclosing the one or more cosmetic products within the cosmetic-product packaging. Alternatively, the lid can be pivotally moved to uncover the second end of the cosmetic-product packaging for accessing the one or more cosmetic products from the second end of the cosmetic-product packaging.

The lid includes the distal hand-digit-slidable flap panel that is tuckable into the retaining slot formed on at least the second planar side panel of the plurality of planar side panels. Throughout the present disclosure, the term “hand-digit-slidable flap” refers to a substantially planar flap of the lid, which can slidably be tucked into the retaining slot for securing the lid into the closed state, and can be slidably removed out of the retaining slot for bringing the lid into the open state. Furthermore, the term “retaining slot” refers to a slit formed on at least the second planar side of the plurality of planar side panels, such a slit being designed to accommodate snugly the hand-digit-slidable flap panel therein. Notably, such a distal hand-digit-slidable flap panel is hand-digit-slid in/out of the retaining slot to pivot the lid into the closed state/the open state. In an example, the distal hand-digit-slidable flap panel may be implemented by way of finger-slidable flap panel. In such an example, the user can use one or more fingers to tuck/remove the distal hand-digit-slidable flap panel into/from the retaining slot. In another example, the distal hand-digit-slidable flap panel may be implemented by way of thumb-slidable flap panel. In such an example, the user can use his/her thumb to tuck/remove the distal hand-digit-slidable flap panel into/from the retaining slot.

Optionally, a shape and size of the retaining slot is designed according to a shape and size of the distal hand-digit-slidable flap panel. Such a design of the retaining slot would allow for accommodating snugly the distal hand-digit-slidable flap panel to bring the lid into the closed state, whilst also allowing the distal hand-digit-slidable flap panel to be slid out of the retaining slot without much force and effort to bring the lid into the open state.

Optionally, the lid includes one or more planar lid panels that are pivotally attached to one or more planar side panels of the plurality of planar side panels. In such a case, the one or more planar lid panels are pivotally movable to cover at least a portion of the second end of the cosmetic-product packaging, thereby forming the second end panel of the cosmetic-product packaging. The one or more planar lid panels could partially or completely cover the second end of the cosmetic-product packaging, in an overlapping or non-overlapping manner. Optionally, the one or more planar lid panels has a rectangular shape, a polygonal shape, a circular shape, a hemispherical shape, an elliptical shape, a freeform shape, or any combination of the above.

Optionally, the one or more planar lid panels include a first planar lid panel, wherein a first end of the first planar lid panel is pivotally attached to a lateral edge of the first planar side panel of the plurality of planar side panels, and wherein a second end of the of the first planar lid panel is pivotally attached to the distal hand-digit-slidable flap panel. Therefore, the first planar lid panel acts as a proximal panel of the lid that is proximal to the point of attachment of the lid with the first planar side panel. Notably, such mutual pivotal attachment of the first planar lid panel and the distal hand-digit-slidable flap panel allows for pivotally turning the lid to cover the second end panel by way of the first planar lid panel when the distal hand-digit-slidable flap panel is hand-digit-slid into the retaining slot to pivot the lid into the closed state. Optionally, that first planar lid panel has a rectangular shape wherein the first end of the first planar lid panel is opposite to the second end of the first planar lid panel.

Optionally, the one or more planar lid panels include at least a second planar lid panel, wherein the second lid panel is pivotally attached to an edge of a planar side panel of the plurality of planar side panels. Notably, such pivotal attachment of the second planar lid panel and the edge of the planar side panel of the plurality of planar side panels allows for pivotal turning of the second planar lid panel in a manner that it substantially covers the second end of the cosmetic-product packaging, thereby forming an additional cover-like arrangement at the second end of the cosmetic-product packaging. The at least one second planar lid panel provides an additional cover for the one or more cosmetic products, and therefore, has to be pivotally moved away to uncover the second end of the cosmetic-product packaging to access the one or more cosmetic products. It will be appreciated that the one or more planar lid panels could include multiple planar lid panels, a number of such planar lid panels being equal to or less than a number of the plurality of planar side panels (of the elongate packaging). In an example, the one or more planar lid panels may include a second planar lid panel and a third planar lid panel, wherein the second planar lid panel is pivotally attached to an edge of a third planar side panel (among the plurality of planar side panels) and the third planar lid panel is pivotally attached to an edge of a fourth planar side panel (among the plurality of planar side panels), and wherein the second planar lid panel and the third planar lid panel fully cover the second end of the cosmetic-product packaging, in an overlapping manner.

Optionally, a distal end of the lid is outwardly curved according to a first radius, and the retaining slot is curved to a second radius, wherein the first and second radii are mutually identical, such that the distal end of the lid overlays the retaining slot in a curved manner when the distal end is hand-digit-slid to overlay the retaining slot; by “mutually identical” is meant, for example, to within +/−20% difference, more optionally to within +/−5% difference. Notably, the distal end of the lid refers to a distal end of the distal-hand-digit slidable flap panel. Such a distal end would lie under the retaining slot, within the internal region of the elongate packaging, when the distal hand-digit-slidable flap panel is tucked into the retaining slot. Moreover, a shape and/or a size of the distal end of the lid and the retaining slot is substantially mutually identical; for example, by “substantially” is meant identical to within +/−20% in physical dimensions, more optionally to within +/−5% in physical dimensions. As a result, the retaining slot would allow for accommodating snugly the distal end of the lid to bring the lid into the closed state whilst also allowing the distal end of the lid to be conveniently slid out of the retaining slot to bring the lid into the open state. In an example, the cosmetic-product packaging may be manufactured as an elongate cuboidal packaging. In such an example, the elongate packaging may have four planar side panels SP1, SP2 SP3 and SP4, one first end panel EP1 and one second end panel EP2 implemented as the lid. Furthermore, in such an example, the elongate packaging may have the retaining slot formed on at least the second planar side panel (for example, the planar side panel SP2) of the four planar side panels SP1 to SP4. Moreover, in such an example, the distal end of the lid may be outwardly curved according to the first radius, and the retaining slot may be curved to the second radius mutually identical to the first radius. In such an example, the distal hand-digit-slidable flap panel may be of length substantially more, for example greater than 2 mm, more optionally more than 5 mm, and yet more optionally more than 10 mm, than a distance between the second end panel EP2 and the retention slot formed on the planar side panel SP2. As a result, the distal end of the lid overlays the retaining slot in a curved manner when the distal end is hand-digit-slid to overlay the retaining slot, and the distal end of the lid can be ticked into the retaining slot.

The elongate packaging surrounds the internal region thereof for accommodating the one or more cosmetic products that are user-accessible when the distal hand-digit-slidable flap panel is hand-digit-slid out of the retaining slot to pivot the lid into the open state. Throughout the present disclosure, the term “internal region” relates to a three-dimensional space within the elongate packaging, within which the one or more cosmetic products can be accommodated. Notably, the plurality of planar side panels, the first end panel and the second end panel collectively form boundaries of the internal region. The one or more cosmetic products can be completely stored within the internal region and be carefully protected within the cosmetic-product packaging. In operation, when the distal hand-digit-slidable flap panel is tucked into the retention slot to pivot the lid into the closed state, the internal region of the cosmetic-product packaging is inaccessible to the user. Furthermore, when the distal hand-digit-slidable flap panel is hand-digit-slid out of the retention slot to pivot the lid into the open state, the internal region of the cosmetic-product packaging is accessible to the user. Therefore, the one or more cosmetic products arranged within the internal region are user-inaccessible when the lid is in the closed state and, the one or more cosmetic products within the internal region are user-accessible when the lid is in the open state.

Optionally, the elongate packaging, in its internal region, includes an internal divider for accommodating in a spatially separated manner the one or more cosmetic products, wherein the internal divider is optionally integral to the plurality of planar side panels, the first end panel and the second end panel, wherein these panels are formed from a single sheet of material during manufacture. Throughout the present disclosure, the term “internal divider” relates to a separation arrangement provided within the internal region of the elongate packaging, wherein the separation arrangement allows for accommodating the one or more cosmetic products in a spatially separated manner. The internal divider allows for compartmentalizing the internal region of the elongate packaging into a plurality of compartments, for properly organizing the one or more cosmetic products within the internal region. Notably, a shape and a size of the internal divider is selected in such a manner that the internal divider is completely arranged within the internal region of the elongate packaging. In an example, the internal divider runs substantially along an elongate axis of the elongate packaging. In another example, the internal divider runs substantially along a lateral axis of the elongate packaging. In yet another example, the internal divider is arranged along a combination of both the elongate axis and the lateral axis.

As mentioned above, the internal divider is optionally integral to the plurality of planar side panels, the first end panel and the second end panel. In such a case, the internal divider is not separate from the aforesaid panels since, the aforesaid panels and the internal divider are formed from the single sheet. As a result, the internal divider is not removable and/or detachable from the aforesaid panels.

As mentioned above, optionally, the plurality of planar side panels, the first end panel the second end panel and the internal divider are formed from the single sheet of material during manufacture. Therefore, the cosmetic-product packaging is easily manufactured from the single sheet of material by employing a simple folding method. In such a case, the sheet of the single material is folded in a manner that all planes of the cosmetic-product packaging are formed by different folded planes of the single sheet. Such a simple folding method allows for rapid assembly, and therefore, such a cosmetic-product packaging can be easily manufactured by employing manual workforce, semi-automated machinery, or automated machinery. Notably, in such a case, less material is used during the manufacture of the cosmetic-product packaging since constituent portions of the cosmetic-product packaging are integral to one another.

Optionally, the single sheet of material has a thickness in a range of 0.1 to 2 mm, more optionally in a range of 0.3 mm to 2 mm. Such a sheet can then be easily folded to form the cosmetic-product packaging. In an example, the thickness of the single sheet of material may be 0.1, 0.2, 0.3, 0.5, 0.7, 0.9, 1, 1.4, 1.6, 1.8 or 2 mm.

Optionally, the single sheet of material has an outer surface that is printable with an image, and is wipe-cleanable (namely, “wipe-clean”), for example by using water, a combination of water and detergent, or an alcohol-based cleaning agent. In such a case, the outer surface is optionally provided with a finish onto which the image can be printed.

Such a finish could be a glossy finish, a matte finish, a patterned finish, an embossed finish and the like. Notably, the image printed upon the outer surface of the sheet enhances a visual appearance of the cosmetic-product packaging. Furthermore, such an image can also be employed to convey information to potential buyers and users of the one or more cosmetic products enclosed within the cosmetic-product packaging; for example, such information pertains to instructions regarding a manner of use of the one or more cosmetic products. Examples of such an image include, but are not limited to, a brand name of the manufacturer of the one or more cosmetic products, a logo of the manufacturer of the one or more cosmetic products, a shade of the one or more cosmetic products, a collection to which the one or more cosmetic products belongs, a price of the one or more cosmetic products, an expiry date of the one or more cosmetic products, directions for use of the one or more cosmetic products, an image, an abstract design, a pattern, a text, and one or more numerical characters. In an example, the outer surface of the single sheet of material may be provided with a glossy finish and the brand name of the manufacturer of the one or more cosmetic products and the shade of the one or more cosmetic products may be printed onto such outer surfaces. Furthermore, in such a case, the outer surface of the single sheet of material is wipe-cleanable (namely, “wipe-clean”). Optionally, in this regard, the outer surface of the single sheet of material has a wipe-clean surface coating thereon. Therefore, such an outer surface could be wiped clean by way of dry cleaning techniques or wet cleaning techniques. In the dry cleaning techniques, the user may clean the outer surface using a dry material (such as a dry napkin or a dry tissue) whereas, in the wet cleaning techniques, the user may clean the outer surface using rub a damp material (such as a damp napkin or a damp cloth) or a wet material (such as a cleaning spray). More optionally, the wipe-clean surface coating acts as a water-proof coating to allow for cleaning the outer surface by way of the wet cleaning techniques. In an example, the outer surface can have a wax coating thereon. Beneficially, the wax coating at least partially prevents water drops to be absorbed within such surface. In another example, the outer surface can have a plastics-material coating thereon that allows the user to wipe such surfaces with a wet cleaning material.

Optionally, an inner surface of the single sheet is printable with the image. This would enhance a visual appearance of the internal region of the cosmetic-product packaging.

Optionally, the elongate packaging is fabricated from a liquid-absorbent material, and the internal divider separates the one or more cosmetic products to reduce smearing or cross-contamination between the one or more cosmetic products when stored in the cosmetic-product packaging. Such a liquid-absorbent material could be a porous material that absorbs liquid spills or oozing from the one or more cosmetic products. In such a case, a thickness of the material used for fabricating the elongate packaging is selected to be such that the elongate packaging prevents such liquid spills or oozing from the one or more cosmetic products to percolate to the outer surface of the elongate packaging. Generally, the body of the one or more cosmetic products contains the one or more cosmetic products therein to avoid any undesirable spillage. However, in an unfortunate scenario of spillage or oozing of the one or more cosmetic products, such an absorbent porous material of the elongate packaging comes in handy to protect the cosmetic-product packaging from liquid damage or spotting. Notably, the liquid absorbent material used in fabricating the elongate packaging is a cellulosic or a fiber-based product, such as tissue paper, cotton, sponge and fluff pulp. Therefore, the elongate packaging also provides the one or more cosmetic products protection from physical damages (for example, damage caused by accidental crushing, falling and the like).

As mentioned above, the internal divider optionally spatially separates the one or more cosmetic products to reduce smearing or cross-contamination between the one or more cosmetic products when stored in the cosmetic-product packaging. In other words, the internal divider creates a physical barrier between the one or more cosmetic products stored within the cosmetic-product packaging. As a result, when any cosmetic product oozes out, it does not smear a body of another cosmetic product within the same internal region of the cosmetic-product packaging. Optionally, the internal divider also provides a barrier to reduce cross-contamination between the one or more cosmetic products, for example, such as mixing of fragrances of the one or more cosmetic products. It will be appreciated that the material of the internal divider is selected in such a manner that it forms a barrier against smearing (for example, such as a liquid barrier) and cross-contamination (for example, such as an air barrier).

Optionally, the internal divider is fabricated with a shock absorbing material to protect the one or more cosmetic products arranged within the cosmetic-product packaging from undesirable physical shocks. Such physical shocks could occur on account of physical impacts (for example, such as falls, crushing, rough handling, friction with surfaces or other objects, and the like) on the cosmetic-product packaging, as well as internal movement of the one or more cosmetic products within the interior region of the elongate packaging. Examples of such a shock absorbing material include, but are not limited to, foam, cloth, soft plastics materials, gel liners and silicone (for example, biodegradable silicone).

Optionally, the internal divider is formed from a sheet that is different from the sheet used to form the plurality of planar side panels, the first end panel and the second end panel. Therefore, in such a case, the internal divider can be easily removed from within the internal region of the elongate packaging. For example, when the internal divider gets worn out (for example, due to degradation upon prolonged exposure of liquid spills or oozing from the one or more cosmetic products), it can be removed and replaced easily.

Optionally, the internal divider defines a plurality of elongate compartments for receiving the one or more cosmetic products. More optionally, the internal divider includes one or more internal planar panels for defining the plurality of elongate compartments. In such a case, an arrangement of the one or more internal planar panels within the internal region is based upon a desired elongate arrangement of the one or more cosmetic products. In an example, the internal region may be divided by way of one internal planar panel into two elongate compartments that extend along a length of the elongate packaging. In such an example, two elongate cosmetic products (for example, such as kohl sticks, lip-liners, and the like) may be stored within the two elongate compartments.

Optionally, the internal divider defines a plurality of lateral compartments for receiving the one or more cosmetic products. In such a case, an arrangement of the one or more internal planar panels within the internal region is based upon a desired lateral arrangement of the one or more cosmetic products. In an example, the internal region may be divided by way of one internal planar panel into two lateral compartments that extend along a lateral width of the elongate packaging. In such an example, two wide cosmetic products (for example, such as face creams, compact powder, blush, and the like) may be stored within the two lateral compartments. Optionally, the internal divider is retained by way slide fit within the cosmetic-product packaging, and can be slid out for a given user to access a cosmetic-product protected by the internal divider.

Optionally, the internal divider defines a plurality of grid-like compartments for receiving the one or more cosmetic products. In such a case, an arrangement of the one or more internal planar panels within the internal region is based upon a desired grid-like arrangement of the one or more cosmetic products. In an example, the internal region may be divided by way of two internal planar panels, one internal planar panel being arranged along the length of the elongate packaging and another internal planar panel being arranged along a lateral width of the elongate packaging to form a 2*2 grid of four spatially separate chambers within the internal region. In such an example, four cosmetic products may be stored within the internal region, one product being stored per chamber of the internal region.

Optionally, the single sheet of material is adhesively bonded in at least a portion of its surface area. In such a case, the “surface area” of the single sheet encompasses surface areas of the plurality of the planar side panels, the first end panel, the second end panel and the internal divider. Notably, an adhesively-bonded portion of the single sheet is thicker, stronger and more rigid as compared to other unbonded portions of the single sheet. Furthermore, optionally, such a portion of the single sheet that is adhesively bonded acts as a supporting portion which facilitates in maintaining a structure of the internal divider with respect to at least one of: the plurality of the planar side panels, the first end panel, the second end panel. In other words, the adhesively-bonded portion of the single sheet allows for keeping intact a structure of the internal divider for spatially separating space within the internal region in a desired manner. As an example, a portion of the single sheet that corresponds to an internal planar panel of the internal divider and a given planar side panel of the plurality of planar side panels, may be adhesively bonded. In such an example, the adhesive bonding between the internal planar panel of the internal divider and the given planar side panel secures the internal planar panel to one side of the elongate packaging, thereby, providing support for the structure of the internal divider.

Optionally, the adhesive bonding is included along an elongate planar side panel of the plurality of planar panels to provide rigidity to the cosmetic-product packaging, and a distal planar panel of the internal divider is adhesively bonded to a same planar side panel into which the retaining slot is formed. In such a case, any elongate planar side panel of the plurality of planar panels can be adhesively bonded in at least a portion of its surface area, to form a multi-layered side panel of the elongate packaging. Such a multi-layered side panel is thick, and provides rigidity to the cosmetic-product packaging since the multi-layered side panel would not be deformed or torn easily. Moreover, when the distal planar panel of the internal divider is adhesively bonded to the second planar side panel (which is the same planar side panel into which the retaining slot is formed), there are provided substantially stable (namely, firmly fixed or firmly secured) compartments within the internal region of the elongate packaging to accommodate the one or more cosmetic products. In such a case, at least an end (for example, such as a distal end) of the distal planar panel of the internal divider is adhesively bonded along the second planar side panel to form substantially-fixed and well-structured compartments within the internal region. Furthermore, a surface of the distal planar panel of the internal divider can also be adhesively bonded to the second planar side panel for providing rigidity to at least a portion of the second planar side panel.

In an embodiment, the distal planar panel of the internal divider is adhesively bonded to a portion of the planar side panel in which the retaining slot is formed, wherein the portion is spatially remote from the retaining slot. In such a case, spatially remote portions of the second planar side panel (into which the retaining slot is formed) include inner surface portions of the second planar side panel that lie substantially away from the retaining slot, for example, such as peripheral surface portions of the second planar side panel that lie proximal to the first end panel and the second end panel of the elongate packaging. Therefore, in such an embodiment, a portion of an inner surface of the second planar side panel which is proximal to the retaining slot is free from fixed, adhesive structural obstructions. As a result, the distal hand-digit-slidable flap panel can be slidably tucked inside the retaining slot easily in the closed state.

In another embodiment, a portion of the internal divider near the lid is devoid of the distal planar panel that is adhesively bonded to the planar side panel into which the retaining slot is formed. In such a case, the distal planar panel of the internal divider is adhesively bonded along the inner surface of the second planar side panel (which is the planar side panel into which the retaining slot is formed), in a manner that the distal planar panel is present only along a portion of the internal divider which is away from the lid. Therefore, in the absence of the distal planar panel near the lid, there would exist a gap between the retaining slot and the portion of the internal divider near the lid. As a result, the distal hand-digit-slidable flap panel can be tucked inside such a gap for bringing the lid into the closed state.

Optionally, the distal hand-digit-slidable flap panel of the lid is provided on its exterior-facing surface with a friction-enhancing surface finish that enhances hand-digit frictional grip onto the distal hand-digit-slidable flap panel. In such a case, the friction-enhancing surface finish, for example, such as a series of raised ridges, sandpaper with friction-enhancing particles such as substantially small metallic particles, diamond or glass particles and the like, can be provided to enhance the hand-digit frictional grip. Therefore, the user can slidably move the distal hand-digit-slidable flap panel without slippage directly into the retaining slot. Beneficially, such a friction-enhancing surface finish allows users having hand-digit dexterity problems to use the cosmetic-product packaging without much trouble. Furthermore, such a surface finish lends a distinctive appearance to the lid, thereby enhancing a visual appearance of the cosmetic-product packaging. Optionally, the surface finish provides an optical glitter effect that enables the cosmetic-product packaging to me readily identified and found within a collection of a plurality of diverse cosmetic-product packagings.

Optionally, the elongate packaging has a length in a range of 10 cm to 18 cm when in a closed state, a first lateral width in a range of 2 cm to 6 cm, and a second lateral width in a range of 1 cm to 3 cm. Notably, the length of the elongate packaging substantially corresponds to a longitudinal dimension of the plurality of planar side panels of the elongate packaging, since the plurality of side panels are arranged along an elongate axis of the cosmetic-product. Similarly, the first lateral width substantially corresponds to a width of the elongate packaging at the first end of the elongate packaging and the second lateral width substantially corresponds to a width of the elongate packaging at the second end of the elongate packaging. In other words, the first lateral width and the second lateral width substantially corresponds to a lateral dimension of the first end panel and a lateral dimension of the second end panel, respectively, since the first end panel and the second end panel are arranged along a lateral axis of the cosmetic-product that runs along a width of the cosmetic-product packaging. The elongate length of the elongate packaging may be, for example, 10, 11, 12, 13, 14, 15, 16, 17 or 18 cm, whereas the first lateral width of the elongate packaging may be, for example, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8 or 6 cm and the second lateral width of the elongate packaging may be, for example, 1, 1.2, 1.4, 1.6, 1.8, 2, 2.2, 2.4, 2.6, 2.8 or 3 cm.

Optionally, the first lateral width is equal to the second lateral width. Optionally, in such a case, the first and second lateral width of the elongate packaging are in range of 2 cm to 3 cm. Alternatively, optionally, the first lateral width and the second lateral width are unequal.

Optionally, the cosmetic-product packing is implemented in a tapered form along its elongate length and/or along at least one of its lateral lengths.

The present disclosure also relates to the method as described above. Various embodiments and variants disclosed above apply mutatis mutandis to the method.

Optionally, the method further includes manufacturing the distal end of the lid to be outwardly curved according to the first radius, and the retaining slot to be curved to the second radius, wherein the first and second radii are mutually identical, such that the distal end of the lid overlays the retaining slot in the curved manner when the distal end is hand-digit-slid to overlay the retaining slot.

Optionally, the method further includes fabricating the elongate packaging from at least one of: the paper material, the cardboard material.

Optionally, the method further includes arranging for the elongate packaging, in its internal region, to include the internal divider for accommodating in a spatially separated manner the one or more cosmetic products, wherein the internal divider is integral to the plurality of planar side panels, the first end panel and the second end panel, wherein these panels are formed from the single sheet of material during manufacture.

Optionally, in the method, the single sheet of material is adhesively bonded in at least a portion of its surface area.

Optionally, in the method, the single sheet of material has the outer surface that is printable with the image, and is wipe-cleanable (namely, “wipe-clean”).

Optionally, the method further includes fabricating the elongate packaging from the liquid-absorbent material, and arranging for the internal divider to separate the one or more cosmetic products to reduce smearing or cross-contamination between the one or more cosmetic products when stored in the cosmetic-product packaging.

Optionally, in the method, the internal divider defines the plurality of elongate compartments for receiving the one or more cosmetic products.

Optionally, in the method, the adhesive bonding is included along the elongate planar side panel of the plurality of planar panels to provide rigidity to the cosmetic-product packaging, and the distal planar panel of the internal divider is adhesively bonded to a same planar side panel into which the retaining slot is formed.

Optionally, in the method, the distal planar panel of the internal divider is adhesively bonded to a portion of the planar side panel in which the retaining slot is formed, wherein the portion is spatially remote from the retaining slot.

Optionally, the method further includes arranging for the portion of the internal divider near the lid to be devoid of the distal planar panel that is adhesively bonded to the planar side panel into which the retaining slot is formed.

Optionally, the method further includes providing the distal hand-digit-slidable flap panel of the lid on its exterior-facing surface with the friction-enhancing surface finish that enhances hand-digit frictional grip onto the distal hand-digit-slidable flap panel.

Optionally, the method further includes manufacturing the elongate packaging to have a length in a range of 10 cm to 18 cm when in a closed state, a first lateral width in a range of 2 cm to 6 cm, and a second lateral width in a range of 1 cm to 3 cm.

### DETAILED DESCRIPTION OF THE DRAWINGS

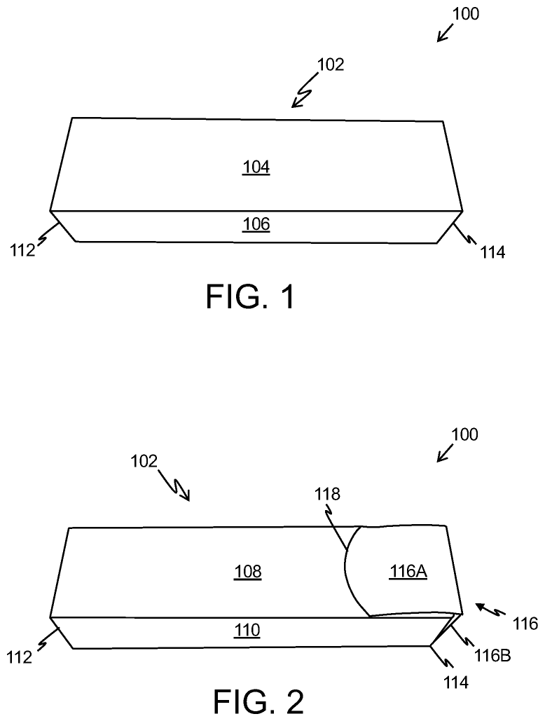

Referring to FIGS. 1 and 2, there are provided illustrations of perspective views of a cosmetic-product packaging 100 in a closed state, in accordance with an embodiment of the present disclosure. It may be understood by a person skilled in the art that the FIGS. 1 and 2 include simplified views of the cosmetic-product packaging 100 for sake of clarity only, which should not unduly limit the scope of the claims herein. The person skilled in the art will recognize many variations, alternatives, and modifications of embodiments of the present disclosure.

As shown in FIGS. 1 and 2, the cosmetic-product packaging 100 is manufactured to be an elongate packaging 102 with a plurality of planar side panels (depicted as a cuboidal packaging with four planar side panels, wherein planar side panels 104 and 106 are visible in FIG. 1 and planar side panels 108 and 110 are visible in FIG. 2), a first end panel 112 and a second end panel 114. Notably, FIG. 1 depicts a top perspective view of the cosmetic-product packaging 100, whereas FIG. 2 depicts a bottom (namely, underside) perspective view of the cosmetic-product packaging 100.

As shown in FIG. 2, the second end panel 114 is implemented as a lid 116 that is pivotally attached to at least a first planar side panel (depicted as the planar side panel 104 in FIG. 1) of the plurality of planar side panels 104 to 110, wherein the lid 116 includes a distal hand-digit-slidable flap panel 116A that is tuckable into a retaining slot 118 formed on at least a second planar side panel (depicted as the planar side panel 108) of the plurality of planar side panels 104 to 110. The elongate packaging 102 surrounds an internal region thereof for accommodating one or more cosmetic products that are user-accessible when the distal hand-digit-slidable flap panel 116A is hand-digit-slid out of the retaining slot 118 to pivot the lid 116 into an open state. The lid 116 is also shown to include a first planar lid panel 1168, wherein a first end of the first planar lid panel 1168 is pivotally attached to a lateral edge of the first planar side panel 104 of the plurality of planar side panels 104 to 110, and wherein a second end of the of the first planar lid panel 1168 is pivotally attached to the distal hand-dig it-slidable flap panel 116A.

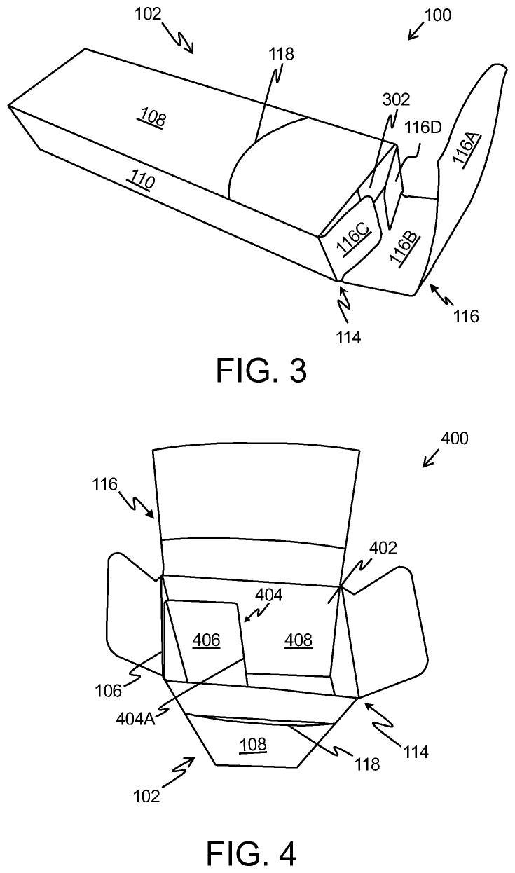

Referring to FIG. 3, there is provided an illustration of a perspective view of a cosmetic-product packaging 100 of FIGS. 1 and 2 in an open state, in accordance with an embodiment of the present disclosure. It may be understood by a person skilled in the art that the FIG. 3 includes a simplified perspective view of the cosmetic-product packaging 100 for sake of clarity only, which should not unduly limit the scope of the claims herein. The person skilled in the art will recognize many variations, alternatives, and modifications of embodiments of the present disclosure.

Notably, in the cosmetic-product packaging 100 of FIG. 3, the distal hand-digit-slidable flap panel 116A is hand-digit-slid out of the retaining slot 118 to pivot the lid 116 into an open state. Therefore, in the open state, an internal region 302 of the elongate packaging 102 (and specifically, of the cosmetic-product packaging 100) is accessible to a user. The internal region 302 can accommodate one or more cosmetic products therein. Furthermore, in the open state, the lid 116 is shown to include a second planar lid panel 116C and a third planar lid panel 116D that are pivotally attached to an edge of the planar side panels 110 and 106 respectively.

Referring to FIG. 4, there is provided an illustration of a perspective view of a cosmetic-product packaging 400 depicting an internal region 402 of the cosmetic-product packaging 400, in accordance with an embodiment of the present disclosure. It will be appreciated that the cosmetic-product packaging 400 is substantially structurally and functionally similar to the cosmetic-product packaging 100 elucidated in conjunction with FIGS. 1, 2 and 3. For example, the cosmetic-product packaging 400 includes the elongate packing 102 with the plurality of planar side panels 104 to 110, the second end panel 114 implemented as the lid 116 and the retaining slot 118. However, the elongate packaging 102, in its internal region 402, includes an internal divider 404 for accommodating in a spatially separated manner one or more cosmetic products, wherein the internal divider 404 is integral to the plurality of planar side panels 104 to 110, the first end panel 112 and the second end panel 114, wherein these panels are formed from a single sheet of material during manufacture. Notably, the single sheet of material is adhesively bonded in at least a portion of its surface area. Furthermore, the adhesive bonding is included along an elongate planar side panel (for example, such as the planar side panel 106) of the plurality of planar panels 104 to 110 to provide rigidity to the cosmetic-product packaging 400, and a distal planar panel 404A of the internal divider 404 is adhesively bonded to a same planar side panel 108 into which the retaining slot 118 is formed. In FIG. 4, the distal planar panel 404A of the internal divider 404 is adhesively bonded to a portion of the planar side panel 108 in which the retaining slot 118 is formed, wherein the portion is spatially remote from the retaining slot 118. As shown, the internal divider 404 defines a plurality of elongate compartments (depicted as an elongate compartment 406 and an elongate compartment 408) for receiving the one or more cosmetic products.

It may be understood by a person skilled in the art that the FIG. 4 includes a simplified view of the internal region 402 for sake of clarity only, which should not unduly limit the scope of the claims herein. The person skilled in the art will recognize many variations, alternatives, and modifications of embodiments of the present disclosure.

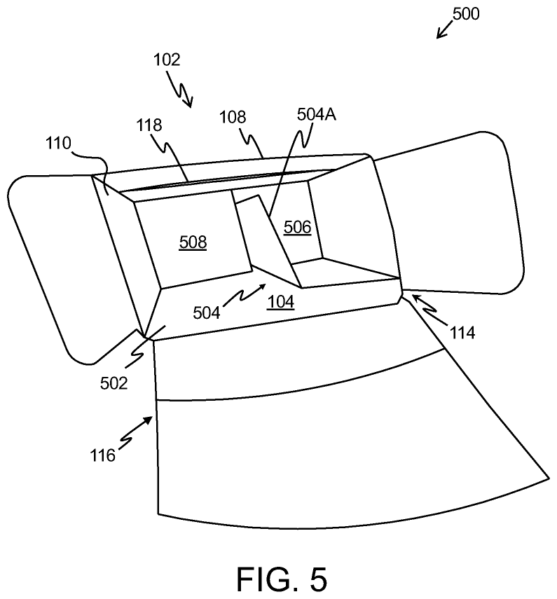

Referring next to FIG. 5, there is provided an illustration of a perspective view of a cosmetic-product packaging 500 depicting an internal region 502 of the cosmetic-product packaging 500, in accordance with another embodiment of the present disclosure. It will be appreciated that the cosmetic-product packaging 500 is substantially structurally and functionally similar to the cosmetic-product packaging 100 elucidated, namely explained, in conjunction with FIGS. 1, 2 and 3. For example, the cosmetic-product packaging 500 includes the elongate packing 102 with the plurality of planar side panels 104 to 110, the second end panel 114 implemented as the lid 116 and the retaining slot 118. However, the elongate packaging 102, in its internal region 502, includes an internal divider 504 for accommodating in a spatially separated manner one or more cosmetic products, wherein the internal divider 504 is integral to the plurality of planar side panels 104 to 110, the first end panel 112 and the second end panel 114, wherein these panels are formed from a single sheet of material during manufacture. Notably, the single sheet of material is adhesively bonded in at least a portion of its surface area. Furthermore, the adhesive bonding is included along an elongate planar side panel of the plurality of planar panels 104 to 110 to provide rigidity to the cosmetic-product packaging 500, and a distal planar panel 504A of the internal divider 504 is adhesively bonded to a same planar side panel 108 into which the retaining slot 118 is formed. In FIG. 5, a portion of the internal divider 504 near the lid 116 (specifically, near the second end panel 114) is devoid of the distal planar panel 504A that is adhesively bonded to the planar side panel 108 into which the retaining slot 118 is formed. As shown, the internal divider 504 defines a plurality of elongate compartments (depicted as an elongate compartment 506 and an elongate compartment 508) for receiving the one or more cosmetic products.

It may be understood by a person skilled in the art that the illustration in FIG. 5 includes a simplified view of the internal region 502 for sake of clarity only, which should not unduly limit the scope of the claims herein. The person skilled in the art will recognize many variations, alternatives, and modifications of embodiments of the present disclosure.

Notably, in both FIGS. 4 and 5, a distal end of the lid 116 is outwardly curved according to a first radius, and the retaining slot 118 is curved to a second radius, wherein the first and second radii are mutually identical, such that the distal end of the lid 116 overlays the retaining slot 118 in a curved manner when the distal end is hand-digit-slid to overlay the retaining slot 118. Optionally, the first and second radii can be made large, for example greater than 30 cm, more optionally greater than 50 cm, so that the retaining slot 118 is substantially linear in form.

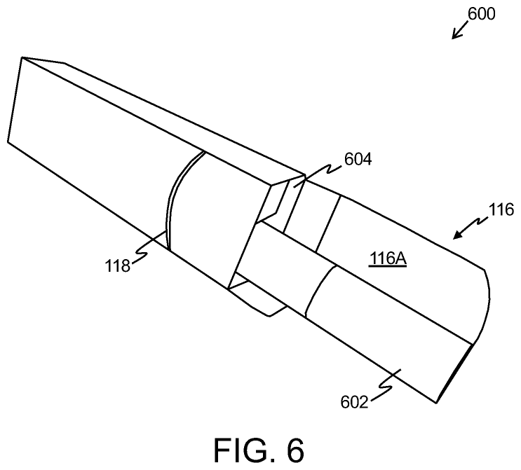

Referring next to FIG. 6, there is provided an illustration in a perspective view of a cosmetic-product packaging 600 in use, in accordance with an embodiment of the present disclosure. It will be appreciated that the cosmetic-product packaging 600 is substantially structurally and functionally similar to the cosmetic-product packaging 100, 400 and 500 explained in conjunction with FIGS. 1 to 3, 4 and 5, respectively. For example, the cosmetic-product packaging 600 includes the lid 116 and the retaining slot 118. However, the cosmetic-product packaging 600 accommodates one or more cosmetic products (depicted as a cosmetic product 602) within an internal region 604 of the cosmetic-product packaging 600. Therefore, when the distal hand-digit-slidable flap panel 116A is hand-digit-slid out of the retaining slot 118 to pivot the lid 116 into the open state, the cosmetic product 602 is user-accessible.

It may be understood by a person skilled in the art that the FIG. 6 is merely an example, which should not unduly limit the scope of the claims herein. The person skilled in the art will recognize many variations, alternatives, and modifications of embodiments of the present disclosure.

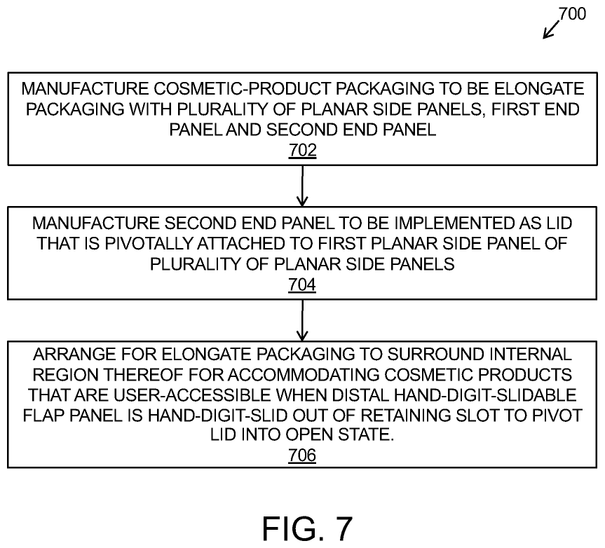

Referring next to FIG. 7, there is provided an illustration of steps of a method 700 of (for) manufacturing a cosmetic-product packaging, in accordance with an embodiment of the present disclosure. At a step 702, the cosmetic-product packaging is manufactured to be an elongate packaging with a plurality of planar side panels, a first end panel and a second end panel. At a step 704, the second end panel is manufactured to be implemented as a lid that is pivotally attached to at least a first planar side panel of the plurality of planar side panels, wherein the lid includes a distal hand-digit-slidable flap panel that is tuckable into a retaining slot formed on at least a second planar side panel of the plurality of planar side panels. At a step 706, the elongate packaging is arranged to surround an internal region thereof for accommodating one or more cosmetic products that are user-accessible when the distal hand-digit-slidable flap panel is hand-digit-slid out of the retaining slot to pivot the lid into an open state.

The steps 702 to 706 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A cosmetic-product packaging, wherein the cosmetic-product packaging is manufactured to be an elongate packaging with a plurality of planar side panels, a first end panel and a second end panel;
the second end panel is implemented as a lid that is pivotally attached to at least a first planar side panel of the plurality of planar side panels, wherein the lid includes a distal hand-digit-slidable flap panel that is tuckable into a retaining slot formed on at least a second planar side panel of the plurality of planar side panels; and
the elongate packaging surrounds an internal region thereof for accommodating one or more cosmetic products that are user-accessible when the distal hand-digit-slidable flap panel is hand-digit-slid out of the retaining slot to pivot the lid into an open state, wherein a distal end of the lid is outwardly curved according to a first radius, and the retaining slot is curved to a second radius, wherein the first radius and the second radius are mutually identical, wherein the distal hand-digit-slidable flap panel is of a length substantially more than a distance between the second end panel and the retaining slot.

2. (canceled)

3. The cosmetic-product packaging of claim 1, wherein the elongate packaging, in its internal region, includes an internal divider for accommodating in a spatially separated manner the one or more cosmetic products, wherein the internal divider is integral to the plurality of planar side panels, the first end panel and the second end panel, wherein these panels are formed from a single sheet of material during manufacture.

4. The cosmetic-product packaging of claim 3, wherein the single sheet of material is adhesively bonded in at least a portion of its surface area.

5. The cosmetic-product packaging of claim 3, wherein the elongate packaging is fabricated from a liquid-absorbent material, and the internal divider separates the one or more cosmetic products to reduce smearing or cross-contamination between the one or more cosmetic products when stored in the 5 cosmetic-product packaging.

6. The cosmetic-product packaging of claim 3, wherein the internal divider defines a plurality of elongate compartments for receiving the one or more cosmetic products.

7. The cosmetic-product packaging of claim 4, wherein the adhesive bonding is included along an elongate planar side panel of the plurality of planar panels to provide rigidity to the cosmetic-product packaging, and a distal planar panel of the internal divider is adhesively bonded to a same planar side panel into which the retaining slot is formed.

8. The cosmetic-product packaging of claim 7, wherein a portion of the internal divider near the lid is devoid of the distal planar panel that is adhesively bonded to the planar side panel into which the retaining slot is formed.

9. The cosmetic-product packaging of claim 1, wherein the distal hand-digit-slidable flap panel of the lid is provided on its exterior-facing surface with a friction-enhancing surface finish that enhances hand-digit frictional grip onto the distal hand-digit-slidable flap panel.

10. The cosmetic-product packaging of claim 1, wherein the elongate packaging has a length in a range of 10 cm to 18 cm when in a closed state, a first lateral width in a range of 2 cm to 6 cm, and a second lateral width in a range of 1 cm to 3 cm.

11. A method of manufacturing a cosmetic-product packaging, wherein the method includes:
(i) manufacturing the cosmetic-product packaging to be an elongate packaging with a plurality of planar side panels, a first end panel and a second end panel;
(ii) manufacturing the second end panel to be implemented as a lid that is pivotally attached to at least a first planar side panel of the plurality of planar side panels, wherein the lid includes a distal hand-digit slidable flap panel that is tuckable into a retaining slot formed on at least a second planar side panel of the plurality of planar side panels, wherein the distal hand-digit-slidable flap panel is of a length substantially more than a distance between the second end panel and the retaining slot;
(iii) arranging for the elongate packaging to surround an internal region thereof for accommodating one or more cosmetic products that are user-accessible when the distal hand-digit-slidable flap panel is hand-digit-slid out of the retaining slot to pivot the lid into an open state; and
(iv) manufacturing a distal end of the lid to be outwardly curved according to a first radius, and the retaining slot to be curved to a second radius, wherein the first radius and the second radius are mutually identical

12. (canceled)

13. The method of claim 11, wherein the method includes arranging for the elongate packaging, in its internal region, to include an internal divider for accommodating in a spatially separated manner the one or more cosmetic products, wherein the internal divider is integral to the plurality of planar side panels, the first end panel and the second end panel, wherein these panels are formed from a single sheet of material during manufacture.

14. The method of claim 13, wherein the single sheet of material is adhesively bonded in at least a portion of its surface area.

15. The method of claim 13, wherein the method includes fabricating the elongate packaging from a liquid-absorbent material, and arranging for the internal divider to separate the one or more cosmetic products to reduce smearing or cross-contamination between the one or more cosmetic products when stored in the cosmetic-product packaging.

16. The method of claim 13, wherein the internal divider defines a plurality of elongate compartments for receiving the one or more cosmetic products.

17. The method of claim 14, wherein the adhesive bonding is included along an elongate planar side panel of the plurality of planar panels to provide rigidity to the cosmetic-product packaging, and a distal planar panel of the internal divider is adhesively bonded to a same planar side panel into which the retaining slot is formed.

18. The method of claim 14, wherein the method includes arranging for a portion of the internal divider near the lid to be devoid of the distal planar panel that is adhesively bonded to the planar side panel into which the retaining slot is formed.

19. The method of claim 11, wherein the method includes providing the distal hand-digit-slidable flap panel of the lid on its exterior-facing surface with a friction-enhancing surface finish that enhances hand-digit frictional grip onto the distal hand-digit-slidable flap panel.

20. The method of claim 11, wherein the method includes manufacturing the elongate packaging to have a length in a range of 10 cm to 18 cm when in a closed state, a first lateral width in a range of 2 cm to 6 cm, and a second lateral width in a range of 1 cm to 3 cm.
